(19) United States
(12) Patent Application Publication
(10) Pub. No.: US 2026/0071642 A1
(43) Pub. Date: Mar. 12, 2026

(54) CONNECTOR

(71) Applicant: Seng Ann ONG, Klang (MY)

(72) Inventor: Seng Ann ONG, Klang (MY)

(21) Appl. No.: 19/298,250

(22) Filed: Aug. 13, 2025

(30) Foreign Application Priority Data
Sep. 7, 2024 (MY) PI2024005220

(51) Int. Cl. F16B 12/24; F16B 12/46

(52) U.S. Cl. CPC F16B 12/24; F16B 12/46; F16B 2200/30; F16B 2200/406

(57) ABSTRACT

The invention discloses a connector (1) for connecting furniture panels (10, 20), the connector (1) comprises an elongate dovetail body (100); and a plurality of protrusions (200), each longitudinally spaced along and extending outwardly from the elongate dovetail body (100); wherein the protrusions (200) are configured to engageably insert to corresponding holes (11) of a first panel (10) for attaching the elongate dovetail body (100) to the first panel (10), and the attached elongate dovetail body (100) is configured for slidable insertion into a groove (21) of a second panel (20), whereby the groove (21) having a complimentary profile that interlocks with the elongate dovetail body (100) upon insertion, thereby connecting the first and second panels (10, 20).

### TECHNICAL FIELD

The invention relates to a connector, and more particularly, to a connector for connecting furniture panels in a tool-less manner.

### BACKGROUND

In Ready-to-Assemble (RTA) furniture, the tongue and groove interlock system is a widely used method for joining furniture panels. This technique involves a protruding tongue on one panel that fits into a corresponding groove on another, creating a secure interlocking joint. Conventionally, the tongue is formed by routing the edge of the panel, a process that is generally cost-effective. However, this method encounters challenges when applied to certain types of panels. Specifically, it is often unsuitable for cost-effective materials such as particle board, which has become increasingly popular. Due to its composition, the particle board is prone to chipping during routing, which compromises the integrity of the tongue and reduces its effectiveness. Additionally, the routing method proves inadequate for panels with narrow thickness, such as those 9 mm or below. In these cases, the resulting tongue fails to provide sufficient structural support and cannot reliably bear the load required for practical applications.

An example of such tongue ang groove systems can be found in the disclosure of an international patent application No. WO2020175978A1. This patent discloses a panel assembly for use in building a furniture unit, the assembly comprising a first panel having at least one projecting tongue for slidably engaging with, and being retained in, a complementary groove formed in a second panel, wherein the tongue is provided with a laminate on at least one surface of the tongue for providing improved structural integrity to the tongue while nevertheless allowing relative sliding movement between the tongue and the groove.

While the patent application offers a solution by incorporating a laminate on the surface of the tongue to enhance structural integrity and reduce the risk of chipping during the routing process, it does not fully resolve the issues. Despite the laminate's effectiveness in mitigating chipping, the problem can still occur, particularly with particle board, which remains susceptible to damage. Furthermore, the solution does not address the inherent limitations associated with panels of narrow thickness.

Accordingly, it would be desirable to provide an improved connector capable of addressing the drawbacks as mentioned above. This invention provides such an apparatus and system thereof.

### SUMMARY

According to an embodiment of the invention, there is a connector for connecting furniture panels, the connector comprises: an elongate dovetail body; and a plurality of protrusions, each longitudinally spaced along and extending outwardly from the elongate dovetail body; wherein the protrusions are configured to engageably insert to corresponding holes of a first panel for attaching the elongate dovetail body to the first panel, and the attached elongate dovetail body is configured for slidable insertion into a groove of a second panel, whereby the groove having a complimentary profile that interlocks with the elongate dovetail body upon insertion, thereby connecting the first and second panels; characterised in that the elongate dovetail body has a generally trapezoidal cross-section defined by a wider side, a narrower side opposite the wider side, and a pair of opposing tapered sides that taper inwardly from the wider side to the narrower side; wherein each protrusion includes a plurality of teeth for firm engagement with an inner surface of the corresponding holes of the first panel, thereby preventing retraction after the insertion of the protrusions.

According to this embodiment, the dovetail elongate body may longitudinally divide into a main body section and at least one extended section.

According to this embodiment, the wider side, the narrower side, the tapered sides, or any combination thereof in the extended section may be slanted inwardly toward a free end of the dovetail elongate body, thereby causing the trapezoidal cross-section to gradually decrease in size toward the free end.

According to this embodiment, the protrusions may extend perpendicularly from the narrower side of the main body section.

According to this embodiment, each protrusion may be of a cylindrical shape, with a tip portion and a base portion, and the width of each protrusion may gradually increase from the tip portion to the base portion.

According to this embodiment, each protrusion may further comprise a plurality of ribs radially distributed around the base portion of each protrusion.

According to this embodiment, the plurality of teeth may be arranged in multiple arrays extending from the ribs at the base portion to the tip portion, and may be radially distributed, leaving a recess between each pair of adjacent arrays.

According to this embodiment, the elongate dovetail body may include a plurality of reinforcement holes or cutouts arranged in an array along its length.

According to this embodiment, the connector may be made of a plastic material including polypropylene, polycarbonate, nylon or any combination thereof.

According to this embodiment, the narrower side of the elongate dovetail body may engage with a surface of the first panel, while the wider side and/or the tapered sides may engage with inner surfaces within the groove of the second panel.

According to this embodiment, the connector may further comprise at least one support member for attaching the protrusions to the elongate dovetail body at a right angle.

According to this embodiment, at least one or both of the tapered sides of the elongate dovetail body include a wave-like surface profile.

One skilled in the art will readily appreciate that the invention is well adapted to carry out the objects and obtain the ends and advantages mentioned, as well as those inherent therein. The embodiments described herein are not intended as limitations on the scope of the invention.

### BRIEF DESCRIPTION OF THE DRAWINGS

For the purpose of facilitating an understanding of the invention, there is illustrated in the accompanying drawing the preferred embodiments from an inspection of which when considered in connection with the following description, the invention, its construction and operation and many of its advantages would be readily understood and appreciated.

FIG. 1 is a top perspective diagram illustrating a first embodiment of a connector.

FIG. 2 is a bottom perspective diagram of the connector.

FIG. 3 is a front view diagram of the connector.

FIG. 4 is a side view diagram of the connector.

FIG. 5 is a perspective diagram illustrating a first panel.

FIG. 6 is a perspective diagram illustrating a second panel.

FIG. 7 is a perspective diagram illustrating the first panel with an attachment of the connector.

FIG. 8 is a perspective diagram illustrating a method for joining the first and second panels using the connector.

FIG. 9 is a side view diagram of the method for joining the first and second panels using the connector.

FIG. 10 is a perspective diagram illustrating the first and second panels in a connected state.

FIG. 11 is a cross-section view of the first and second panels in the connected state.

FIG. 12 is a top perspective diagram illustrating a second embodiment of the connector.

FIG. 13 is a bottom perspective diagram of the connector.

### DETAILED DESCRIPTION

Hereinafter, the invention shall be described according to the preferred embodiments of the present invention and by referring to the accompanying description and drawings. However, it is to be understood that limiting the description to the preferred embodiments of the invention is merely to facilitate discussion of the present invention and it is envisioned that those skilled in the art may devise various modifications without departing from the scope of the appended claim.

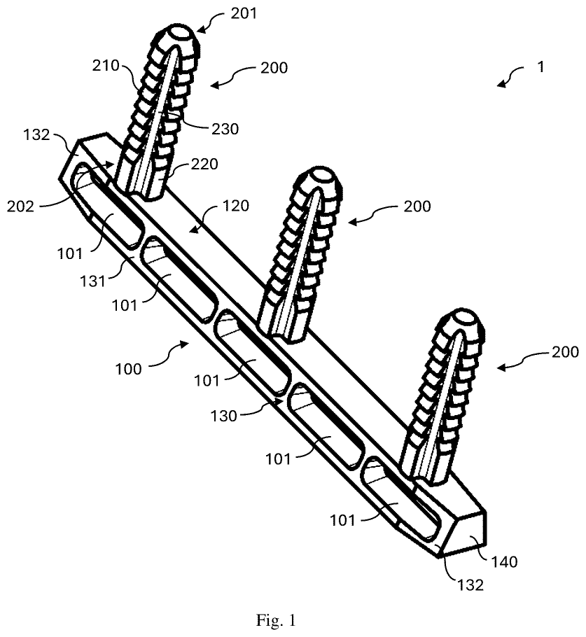

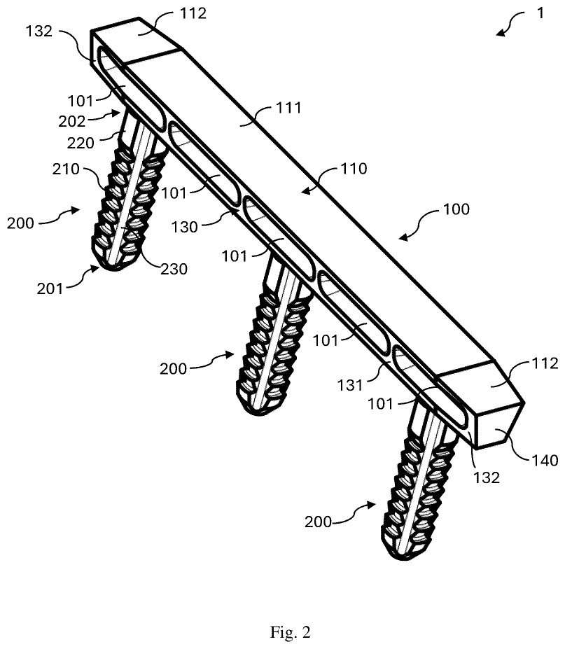

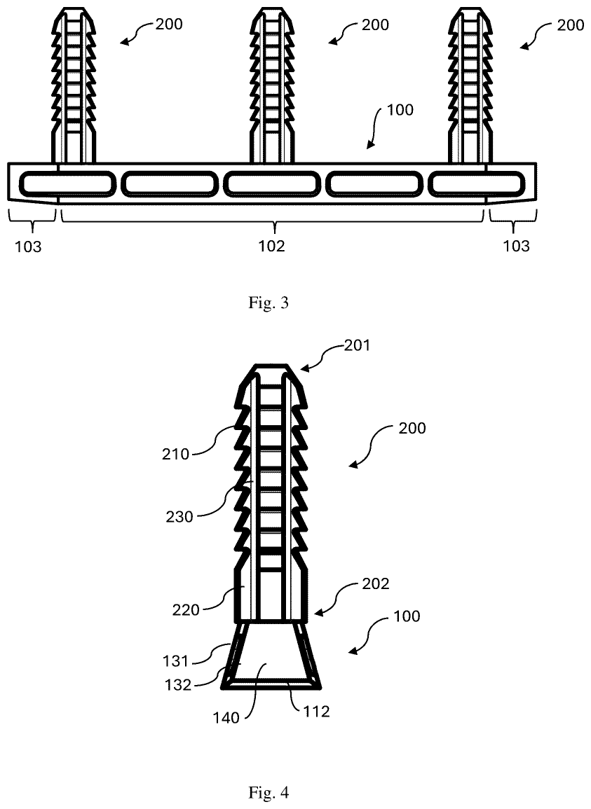

FIGS. 1 to 6 illustrate the first embodiment of the connector (1). Preferably, the connector (1) comprises an elongate dovetail body (100) with a plurality of protrusions (200) that are longitudinally spaced along and extend outwardly from the elongate dovetail body (100). In general, these protrusions (200) are configured to engageably insert into corresponding holes (11) in a first panel (10) for attaching the elongate dovetail body (100) to the first panel (10). Once attached, the elongate dovetail body (100) is then configured to slidable insert into a groove (20) formed in a second panel (21). In this embodiment, the groove (21) has a complementary profile that interlocks with the elongate dovetail body (100) upon insertion, thus connecting the first and second panels (10, 20). The connector (1) can be manufactured as a single-piece structure through a plastic injection molding process. It can be composed of plastic materials such as polypropylene, polycarbonate, nylon or any combination thereof.

Preferably, the elongate dovetail body (100) comprises a generally trapezoidal cross-section, defined by a wider side (110), a narrower side (120) opposite the wider side (110), and a pair of opposing tapered sides (130) that taper inwardly from the wider side (110) to the narrower side (120). The elongate dovetail body (100) can be longitudinally divided into a main body section (102) and a pair of extended sections (103). In the extended sections (103), at least an end portion (112, 132) of the wider side (112) and/or the tapered sides (132) are slanted inwardly toward the free ends (140) of the elongate dovetail body (100), thereby causing the trapezoidal cross-section to gradually decrease in size toward the free ends (140). This allows for easier alignment and smoother insertion of the elongate dovetail body (100) into the complementary groove (21), especially for the initial stage of the insertion. In this embodiment, the groove (21) may also have a dovetail profile that complements the shape of the elongate dovetail body (100). Depending on the application, the end portions of the narrower side (120) may also slant inwardly toward the free ends (140). The length of each extended section (103) can be at least 5% of the length of the main body section (102). The portions (111, 131) of the wider side and/or the tapered side at the main body section (102) are generally flat. Alternatively, the elongate dovetail body (100) may include a plurality of reinforcement holes or cutouts (101) arranged in an array along its length. The reinforcement holes or cutouts (101) reduce the overall weight without significantly compromising the structural integrity of the connector (1). Furthermore, they can provide flexibility to the elongate dovetail body (100), allowing it to deform slightly during insertion into the groove (21) to ensure a snug fit while accommodating any minor inconsistencies in the groove (21) of the furniture panels (10, 20). Additionally, when adhesive such as glue is applied to further strengthen the engagement, the reinforcement holes or cutouts (101) provide spaces for containing the adhesive.

Preferably, the protrusions (200) extend at a right angle from the narrower side (120) of the main body section (102). Each protrusion (200) can have a cylindrical body with a tip portion (201) and a base portion (202). The base portion (202) is located adjacent a surface of the narrower side (120) and the tip portion (201) is located at the free end of the protrusions (200). The base portion (202) may include a plurality of ribs (220) that are radially distributed around the base portion (202). Each protrusion (200) also includes a plurality of teeth (210) can be arranged in multiple arrays extending from the ribs (220) at the base portion (202) to the tip portion (201). The arrays of teeth (210) are also radially distributed, leaving one or more recesses (230) between each pair of adjacent arrays. Each tooth (210) may have serrated profile with sharp or beveled edges to effectively grip onto an inner surface of the corresponding holes (11). Alternatively, the teeth (210) may be arranged in a screw threaded manner. The width of each protrusion (200), inclusive of the teeth (210) and the ribs (220), gradually increases from the tip portion (201) to the base portion (202). Due to the narrowing of the protrusions (200) at the tip portion (201) and the broadening at the base portion (202), the base portion (202) is subjected to higher compression forces during insertion into the corresponding holes (11). This increased compression may cause damage to the teeth (210). In contrast, the ribs (220) are rigid structures that can withstand the compression forces, minimizing the risk of damaging the protrusions (200). Additionally, when adhesive such as glue is applied to further strengthen the engagement, the recesses (230) between each pair of adjacent teeth (210) arrays provide spaces for containing the adhesive.

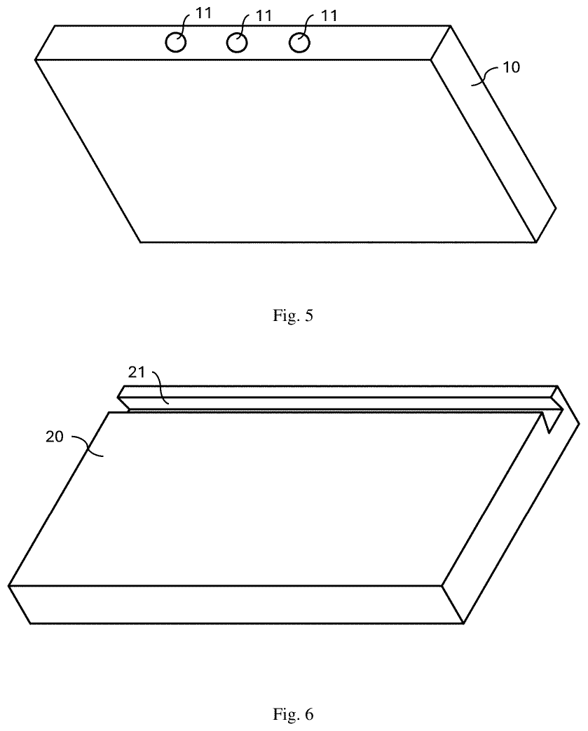

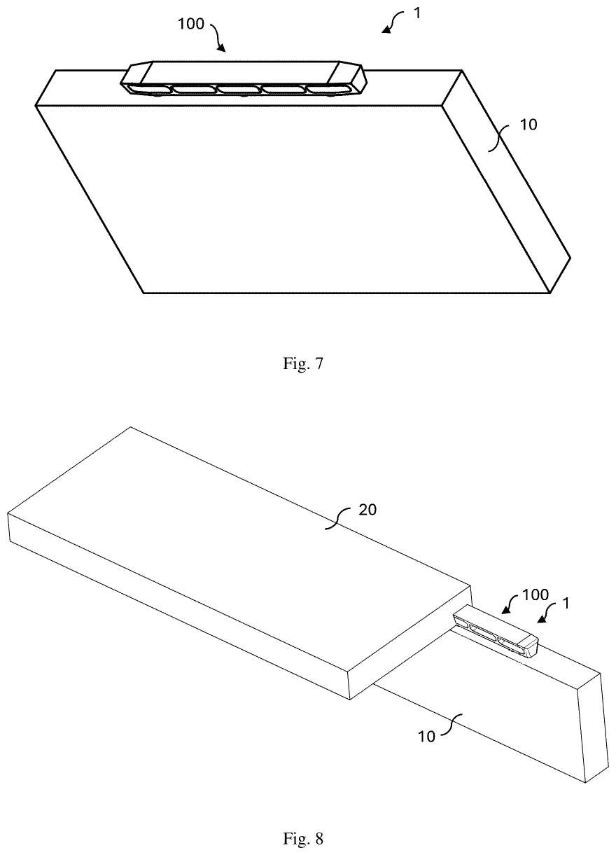

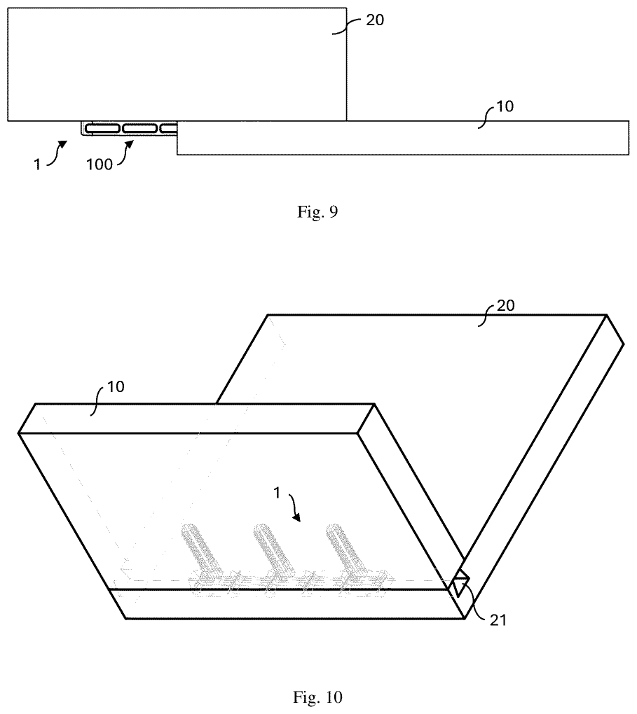

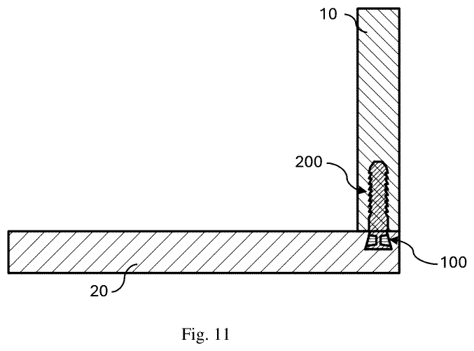

FIGS. 5 and 6 depict the first and second panels (10, 20). Preferably, these panels (10, 20) are made from materials such as particle board, medium or high-density fiberboard, plywood, solid wood, chipboard, or any combination thereof. In a specific embodiment, the thickness of at least the first panel (10) is about 9 mm or lesser. The corresponding holes (11) are preferably positioned along one edge of the first panel (10), while the groove (21) is situated adjacent to an edge of the second panel (20). The groove (21) can be formed by a routing process onto the second panel (20). As illustrated in FIG. 7, the connector (1) is attached to the edge of the first panel (10) by inserting the protrusions (200) into the corresponding holes (11). After the insertion, the narrower side (120) of the elongate dovetail body (100) engages with the surface of the first panel (10), leaving the wider side (110) and/or the tapered sides (130) exposed. Effectively, a tongue profile is formed on the edge of the first panel (10). FIGS. 8 to 11 show the insertion of the attached elongate dovetail body (100) into the groove (21). The exposed wider side (110) and/or tapered sides (120) engage with the inner surfaces of the groove (21) to facilitate the formation of a tongue and groove interlocking joint. The first and second panels (10, 20) can be joined at a right angle. In one alternative embodiment, the connector (1) may further comprise at least one support member (not shown) for connecting the protrusions (200) to the elongate dovetail body (100) in such a way that the protrusions (200) extend perpendicularly to the direction of the wider side (110) is facing.

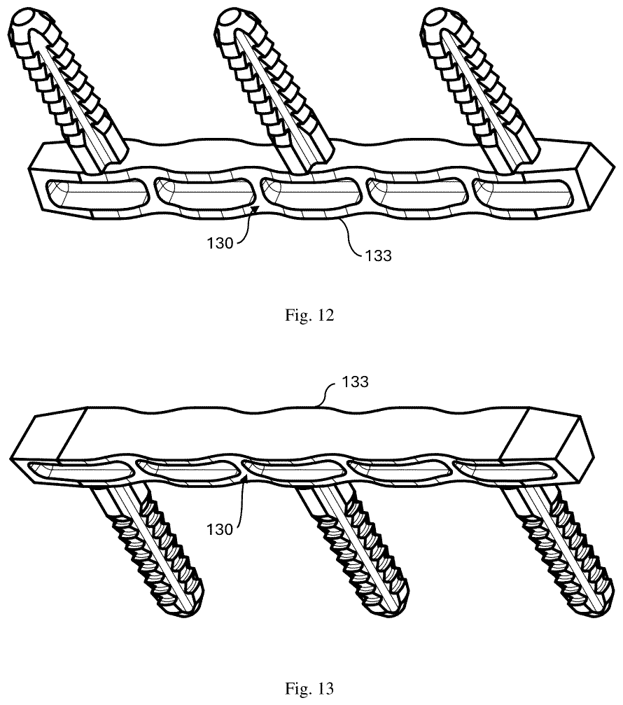

FIGS. 12 & 13 shows the second embodiment of the connector (1). In this embodiment, at least one or both of the tapered sides (130) of the elongate dovetail body include a wave-like surface profile (133). This profile allows the smoother insertion and enhances gripping strength against the inner surfaces of the groove (21), providing better insertion experience and firm engagement compared to the flat surfaces (111, 131) of elongate dovetail body (100) in the first embodiment. It should be noted that the wider side (110) and/or the narrower side (120) can also have similar wave-like surface profile.

The present disclosure includes as contained in the appended claims, as well as that of the foregoing description. Although the invention has been described and illustrated in detail, it is to be understood that the same is by the way of illustration and example, and is not to be taken by way of limitation. The scope of the present invention is to be limited only by the terms of the appended claims.

1. A connector (1) for connecting furniture panels (10, 20), the connector (1) comprising:
an elongate dovetail body (100); and
a plurality of protrusions (200), each longitudinally spaced along and extending outwardly from the elongate dovetail body (100);
wherein the protrusions (200) are configured to engageably insert to corresponding holes (11) of a first panel (10) for attaching the elongate dovetail body (100) to the first panel (10), and the attached elongate dovetail body (100) is configured for slidable insertion into a groove (21) of a second panel (20), whereby the groove (21) having a complimentary profile that interlocks with the elongate dovetail body (100) upon insertion, thereby connecting the first and second panels (10, 20);
characterised in that the elongate dovetail body (100) has a generally trapezoidal cross-section defined by a wider side (110), a narrower side (120) opposite the wider side (110), and a pair of opposing tapered sides (130) that taper inwardly from the wider side (110) to the narrower side (120);
wherein each protrusion (200) includes a plurality of teeth (210) for firm engagement with an inner surface of the corresponding holes (11) of the first panel, thereby preventing retraction after the insertion of the protrusions (200).

2. The connector (1) according to claim 1, wherein the dovetail elongate body (100) longitudinally divided into a main body section (102) and at least one extended section (103), whereby the wider side (110), the narrower side (120), the tapered sides (130), or any combination thereof in the extended section (103) are slanted inwardly toward a free end (140) of the dovetail elongate body (100), thereby causing the trapezoidal cross-section to gradually decrease in size toward the free end (140).

3. The connector (1) according to claim 2, wherein the protrusions (200) extend perpendicularly from the narrower side (120) of the main body section (102).

4. The connector (1) according to claim 1, wherein each protrusion (200) is cylindrical, with a tip portion (201) and a base portion (202), and the width of each protrusion (200) gradually increases from the tip portion (201) to the base portion (202).

5. The connector (1) according to claim 4, wherein each protrusion (200) further comprises a plurality of ribs (220) radially distributed around the base portion (202) of the protrusion (200).

6. The connector (1) according to claim 4, wherein the plurality of teeth (210) are arranged in multiple arrays extending from the ribs (220) at the base portion (202) to the tip portion (201), and are radially distributed, leaving a recess (230) between each pair of adjacent arrays.

7. The connector (1) according to claim 1, wherein the elongate dovetail body (100) includes a plurality of reinforcement holes or cutouts (101) arranged in an array along its length.

8. The connector (1) according to claim 1, is made of a plastic material including polypropylene, polycarbonate, nylon or any combination thereof.

9. The connector (1) according to claim 1, further comprising at least one support member for attaching the protrusions (200) to the elongate dovetail body (100) at a right angle.

10. The connector (1) according to claim 1, wherein at least one or both of the tapered sides (130) of the elongate dovetail body (100) include a wave-like surface profile (133).
